(19) United States
(12) Patent Application Publication
(10) Pub. No.: US 2011/0097142 A1
(43) Pub. Date: Apr. 28, 2011

(54) Weld Rivet Joint

(75) Inventors: Juergen Bassler, Achern (DE); Tycho Eulenstein, Kassel (DE); Rudolf Reinhardt, Esslingen (DE); Heiko Steinmetz, Ohmden (DE); Alexander Theierl, Vaihingen-Ensingen (DE); Bernhard Ziegler, Rechberghausen (DE)

(73) Assignee: DAIMLER AG, STUTTGAART (DE)

(21) Appl. No.: 12/991,008

(22) PCT Filed: Jan. 30, 2009
(86) PCT No.: PCT/EP09/00595

§ 371 Date: Jan. 13, 2011

(30) Foreign Application Priority Data
May 6, 2008 (DE) 10 2008 022 263.1
Jul. 2, 2008 (DE) 10 2008 031 121.9

(51) Int. Cl. F16D 1/068

(52) U.S. Cl. 403/337

(57) ABSTRACT

A weld rivet joint between one or more components and a base component is provided. The one or more components have a hole through which a weld rivet having a head projects with its shank. The shank is welded to the surface of the base component by its end face and is plastically deformed. The weld rivet has a shank that is shorter than its head diameter, and in a transition region between head and shank a continuous annular recess is provided for the accommodation of material displaced in the riveting process and/or for tolerance compensation.

### CROSS-REFERENCE TO RELATED APPLICATIONS

This application is a national stage of PCT International Application No. PCT/EP2009/000595, filed Jan. 30, 2009, and claims priority under 35 U.S.C. § 119 to German Patent Application No. 10 2008 022 263.1, filed May 6, 2008 and to German Patent Application No. 10 2008 031 121.9, filed Jul. 2, 2008, the entire disclosure of the afore-mentioned documents is herein expressly incorporated by reference.

### BACKGROUND AND SUMMARY OF THE INVENTION

In a weld rivet joint, two or more components are joined in one operation involving a welded joint and a plastic deformation during a riveting process. By means of a weld rivet joint, it is possible to join one or more components to a base component by their respective end faces without having to provide a hole penetrating the base component.

To produce the weld rivet joint, a weld rivet is inserted through a hole provided in one or more components until its end face, which is in front in the direction of insertion, contacts the base component. Following this, the end face of the weld rivet is welded to the surface of the base component, usually in a resistance welding process. In the next and final process step, the weld rivet is deformed plastically by the application of a second electric pulse following the first welding pulse after a short interval. This welding pulse heats and softens the weld rivet, which is plastically deformed by a force acting in the longitudinal direction of the weld rivet. The plastic deformation results in a compression of the shank of the weld rivet, which is thereby jammed in the hole of the components to be secured. On completion of the process, the weld rivet shrinks owing to the preceding thermal expansion, resulting in an additional clamping effect of the weld rivet joint and thus in a high strength.

German Patent Document DE 10 2005 006 253 B4 discloses a generic weld rivet joint produced in a single operation is known, wherein the welding process and a plastic deformation of the weld rivet immediately follow each other. By providing a head on the weld rivet, it is in particular possible to join non-metallic components to the metallic base component.

The present invention is based on the problem of specifying an alternative but equivalent embodiment for a weld rivet joint.

According to the invention, this problem is solved by the subject matter of the independent claims. Advantageous further developments form the subject of the dependent claims.

The invention is based on the general idea of providing, on a first weld rivet of a weld rivet joint in a transition region between head and shank, a continuous annular recess designed to receive material displaced in the riveting process and/or for tolerance compensation. The weld rivet forms a part of a weld rivet joint according to the invention between one or more components and a base component, the component(s) having a hole through which the weld rivet provided with a head extends with its shank. In this arrangement, the shank of the weld rivet is shorter in comparison to the head diameter and is therefore particularly suitable for joining thin components such as sheet metal parts. The end face of the weld rivet shank contacts a surface of the base component and is welded to the base component in this region in a first operation. The weld rivet is then heated and softened by a second electric pulse and upset by means of a high compressive force, wherein the axial preload of the weld rivet can be influenced directly by a ratio between an axial length of the recess and the overall length of the weld rivet. In this context, for example, a recess located immediately adjacent to the end region provided for welding is advantageous for a tempering effect provided by the subsequent riveting process wherein the weld rivet is heated again by means of a second electric pulse, which has a beneficial effect on the welding process. The depth of the recess can moreover be used to influence the heating temperature of the weld rivet as it is re-heated during the riveting process, and this temperature can in turn influence the deformability of the weld rivet in the region heated in this way.

In another embodiment of the solution according to the invention, the base component has a cavity which accommodates at least the end region and parts of the shank of the weld rivet. This results in a weld rivet joint with a particularly high preload, as the available shrinkage length of the weld rivet can be increased by the section extending into the cavity.

In a further advantageous embodiment of the solution according to the invention, the end face of the weld rivet shank is conical. As the diameter of the weld rivet increases, the planar welding of a full cross-section becomes more difficult, which is due to the inhomogeneous current and force distribution across the cross-section of the weld rivet. By using the conical end face of the weld rivet shank, it is possible to produce a weldable annular projection which, although it is lost in the welding process, allows for an extremely accurately repeatable weld quality. In this context, it is in particular conceivable to separate the welding process from the subsequent riveting process, in particular using different operations and even different machinery, if the material of the base component differs from the material of the components to be joined thereto and if the weld rivet has a larger diameter. It may for example be advantageous to weld the weld rivet by means of capacitor discharge welding, followed by riveting in another station in a conventional resistance welding machine.

In a further alternative embodiment of the solution according to the invention, the weld rivet is designed as a tubular rivet with a blind hole open either towards the end face of the shank or towards the head. In this way, a particularly light-weight weld rivet can be produced with a small amount of heat and reduced riveting force requirements, wherein, if the end face of the shank is annular, the blind hole provides a location for spatter, so that it cannot endanger the quality of the weld rivet joint to be produced by uncontrolled splashing.

Further important features and advantages of the invention can be derived from the dependent claims, the drawings and the description of the figures with reference to the drawings.

It is understood that the features mentioned above and yet to be explained below can be used not only in the specified combination, but also in other combinations or individually, without exceeding the scope of the present invention.

### BRIEF DESCRIPTION OF THE DRAWING FIGURES

Preferred embodiments of the invention are shown in the drawings and explained in greater detail in the following description, identical reference numbers identifying identical, similar or functionally identical components.

Of the diagrammatic figures:

FIG. 1 is a side view and a sectional view of a weld rivet according to the invention,

FIG. 2a shows the individual components of a weld rivet joint according to the invention,

FIG. 2b shows a weld rivet joint after the welding process,

FIG. 2c shows a completed weld rivet joint,

FIG. 3a shows another embodiment in a view corresponding to FIG. 2a,

FIG. 3d shows a completed weld rivet joint with the components from FIG. 3a,

FIGS. 4a, b show an exploded view and a completed weld rivet joint with a weld rivet having a countersunk head,

FIGS. 5a, b correspond to FIGS. 4a and b, but show a different embodiment,

FIGS. 6a to 9a are exploded views of a weld rivet joint according to the invention,

FIGS. 6b to 9b show completed weld river joints,

FIG. 10 shows a weld rivet with an integral stud bolt,

FIGS. 11a and 12a show a further embodiment of a weld rivet joint according to the invention with a weld rivet, initially without a head,

FIGS. 11b and 12b show a weld rivet joint made using the components from FIGS. 11a and 12a after the welding process,

FIGS. 11c and 12c show completed weld rivet joints with swaged-on heads,

FIGS. 13a to c show differently shaped end faces of the weld rivet,

FIGS. 14a to d show weld rivets with a polygonal shank or a polygonal head, and

FIGS. 15a to c show a weld rivet joint according to the invention joining a turbine wheel to a shaft.

### DETAILED DESCRIPTION OF THE DRAWING FIGURES

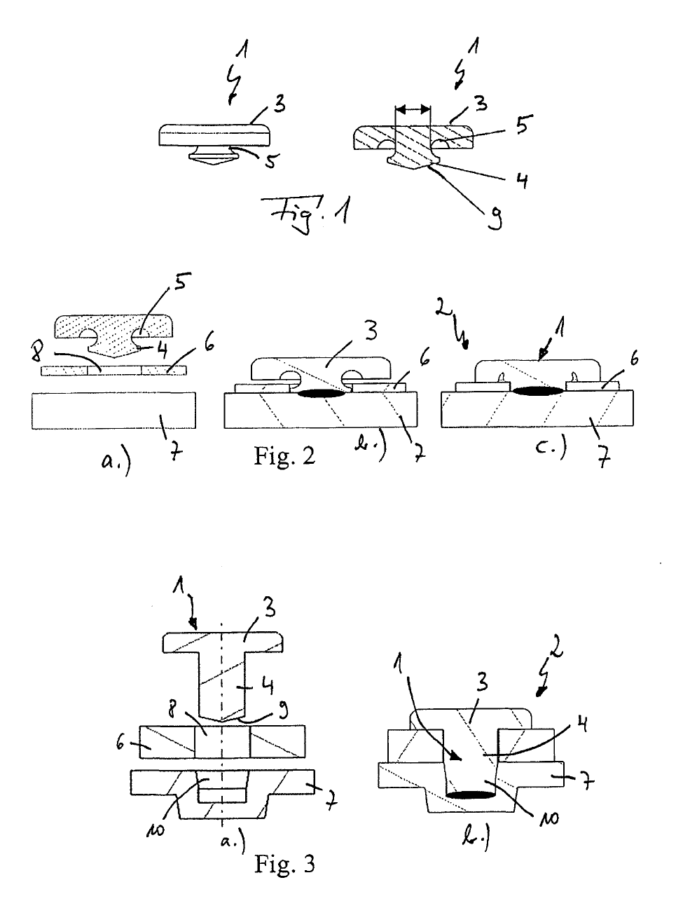

According to FIG. 1, a weld rivet 1 of a weld rivet joint 2 shown by way of example in FIGS. 2b and c comprises a head 3 and a shank 4. In the region of its shank 4, the weld rivet 1 has a continuous annular recess 5, which in the case of the weld rivet 1 according to FIGS. 1 and 2 continues in the head 3 for the accommodation of material displaced in the riveting process and/or for tolerance compensation. The weld rivet joint 2 according to the invention is generally used to join one or more components 6 to a base component 7 (cf. FIG. 2a), the component(s) 6 having a hole 8 through which the weld rivet 1 projects with its shank 4. The embodiment shown in FIGS. 1 and 2 is designed for joining thin components in particular.

The weld riveting process itself is carried out as follows:

The shank 4 of the weld rivet 1 is first inserted through the hole 8 of the at least one component 6 to be joined to the base component 7, until its end face 9 contacts the base component 7. A current pulse is then used to heat the end face 9 of the weld rivet 1, welding it to the base component 7 as shown in FIG. 2b by way of example. After this welded joint has been made between the shank 4 and the base component 7, a further current pulse heats the shank 4 of the weld rivet 1, thereby softening it, so that the application of a compressive force to the weld rivet 1 establishes a firm contact between the head 3 of the latter and the component 6 to be joined. As the weld rivet 1 subsequently cools, it contracts owing to its preceding thermal expansion, resulting in an extremely firm and stable weld rivet joint 2 by means of which very thin components 6 in particular can be secured to the base component 7. In a weld rivet joint 2 of this type, it is further possible to secure a non-metallic component 6 to the base component 7 using a weld rivet joint 2. Particularly advantageous in all of the illustrated weld rivet joints 2 is the fact that the weld rivet joint 2 can be produced from one side only, so that there is no need for a through-hole in the base component 7, for example to insert a screw or bolt. The welded joint can generally be produced by friction or resistance welding.

The weld rivet joint 2 according to the invention in particular allows components 6 made of very different materials to be joined, such as plastics, fibre-reinforced plastics, magnesium, nickel, chromium-nickel, copper etc. The material of the weld rivet 1 will of course have to be matched to the expected thermal and/or mechanical stresses. The welding operation itself can be performed using conventional welding tongs, permitting the use of existing means of production.

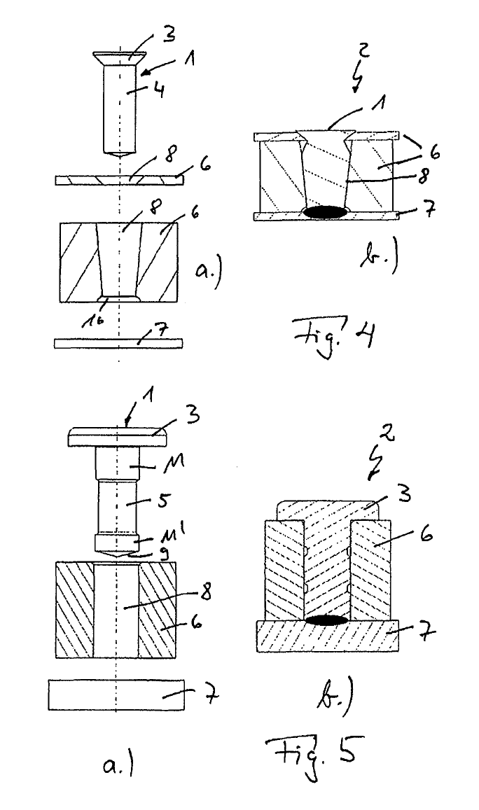

According to FIGS. 3a and 3b, the base component 7 has a cavity 10 which accommodates at least the end region 9 and parts of the shank 4 of the weld rivet 1. This may, for example, be cylindrical like the shank 4 of the weld rivet 1 or at least partially conical as shown in FIG. 3a. With an embodiment of the weld rivet joint 2 according to FIGS. 3a and 3b, a particularly high preload can be obtained, because the shank 4 of the weld rivet 1 can be made longer, so that the thermal shrinkage involved in the cooling of the weld rivet 1 causes a stronger deformation.

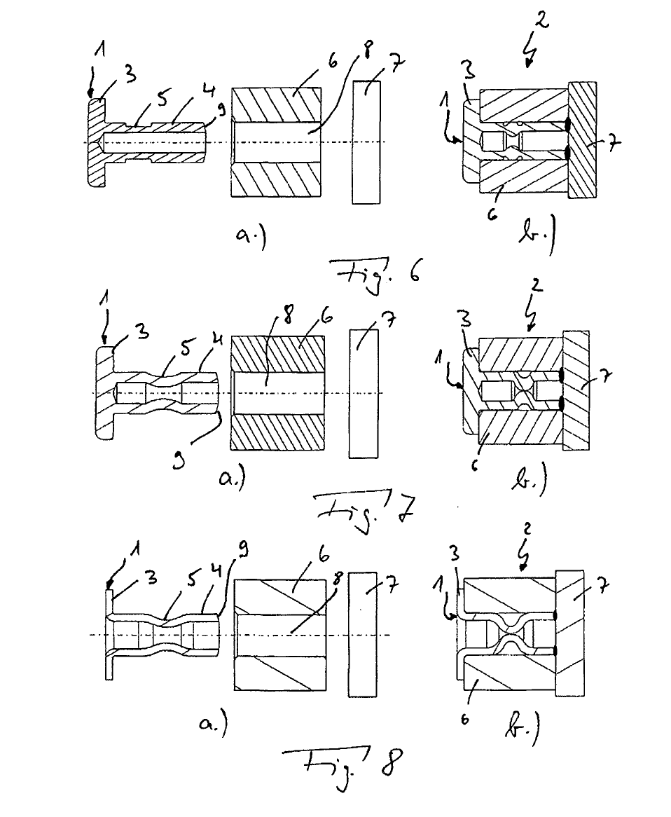

According to FIGS. 4a and 4b, a weld rivet 1 has a cylindrical shank and a head 3 with the shape of a truncated cone which, after the completion of the weld rivet joint 2 as shown by way of example in FIG. 4b, is recessed and therefore flush with a surface of the component 6. The hole 8 of the weld rivet joint 2 shown in FIGS. 4a and 4b is conical in shape and has at the end facing the base component 7 a location space, for example a bead chamber 16 where material produced in the welding process can be accommodated without getting into the space between the component 6 and the base component 7, thereby affecting the quality of the weld rivet joint 2. As a current pulse is applied to the weld rivet 1 in the following riveting process, thereby softening it, it is pushed into the conical hole 8 and preferably deposited on its inner wall. As the weld rivet joint 2 cools, an extremely secure joint is achieved.

As it is not always possible to provide a conical shape for the hole 8, the weld rivet 1 can alternatively be centered as shown in FIGS. 5a and 5b by means of so-called centering sections 11 and 11′, which may be provided axially adjacent to the recess 5. As the weld rivet 1 is riveted as shown in FIG. 5b, it is heated particularly intensively in the region of the recess 5, with the result that this region is deformed particularly strongly. In principle, it is provided that the diameter of the shank 4 defines the nominal diameter of the weld rivet 1 in the region of the recess 5. The axial preload of the weld rivet 1 can be influenced by means of the ratio between the axial length of the recess 5 and the overall length. In addition, it is possible to produce, by using the position of the recess 5, for example close to the weld, an advantageous tempering effect in the subsequent riveting process. The volume will obviously have to be selected while taking into account the tolerance compensation required.

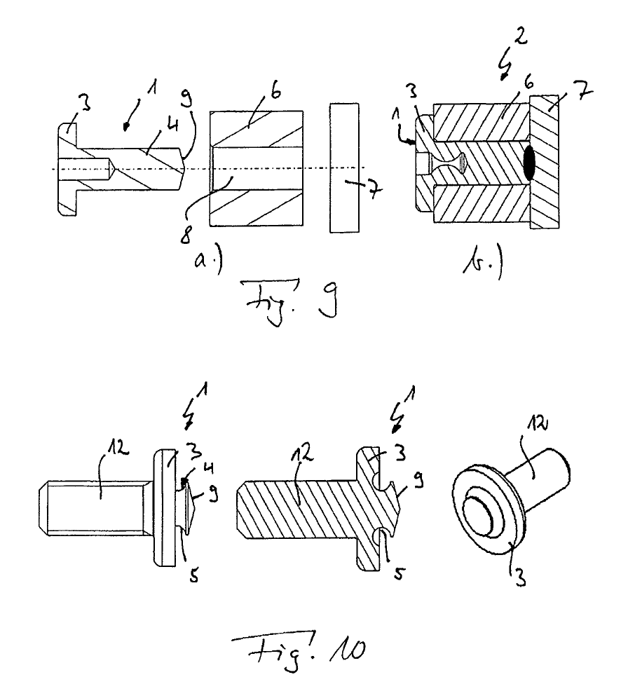

If weld rivet joints 2 are produced using a weld rivet 1 with a large shank diameter, the planar welding of the full cross-section of the end face 9 can be difficult, which is in particular due to the inhomogeneous current and force distribution across the cross-section. For this reason, the end face 9 of the weld rivet 1 is designed conical or that the weld rivet 1 is itself designed as a tubular rivet with an end which is open towards the end face 9 of the shank 4. This end may be designed as a blind hole. Such a tubular rivet is shown by way of example in FIGS. 6 to 8. FIGS. 6b to 8b in particular show that the weld itself between the end face 9 of the shank 4, which is annular in the illustrated embodiment, and the base component 7 is significantly smaller. In all of these variants, the recess 5 can for example be produced by a machining process, in particular turning, or by mechanical pinching. Examples for machining processes are shown in FIGS. 5a and 6a, while pinched recesses 5 are shown in FIGS. 7a and 8a by way of example. In this context, it may be provided that the shank 4 of the weld rivet 1 is designed as a tubular body to the end of which the head 3 is attached. Depending on the design of the recess 5, the deformed weld rivet 1 may have different shapes following the completion of the weld rivet joint 2, as is illustrated in FIGS. 6b to 8b by way of example. The recess 5 may further be produced in an extrusion process.

A weld rivet according to FIGS. 9a and 9b likewise has an open end in the form of a blind hole, which is however open towards the head 3.

FIG. 10 shows a side view, a cross-section and an oblique view of a weld rivet 1 according to the invention, which is provided with stud bolt 12 on the side of the head 3 which is remote from the shank 4, so that further components can be fitted.

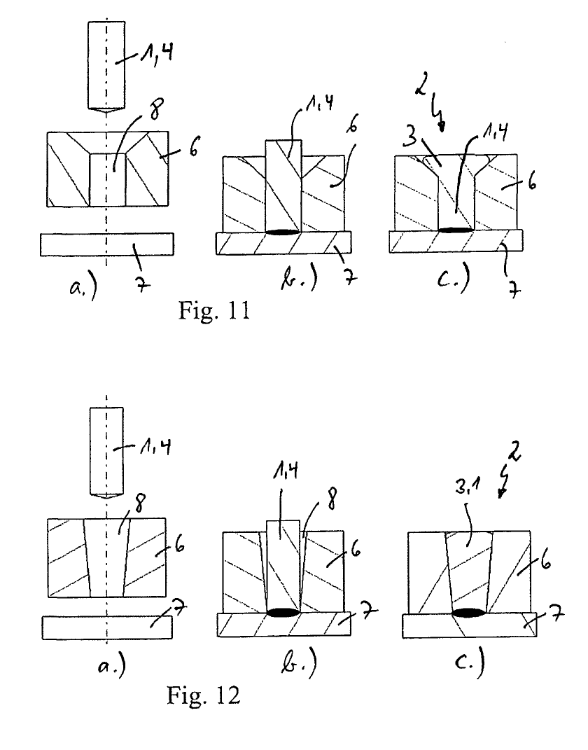

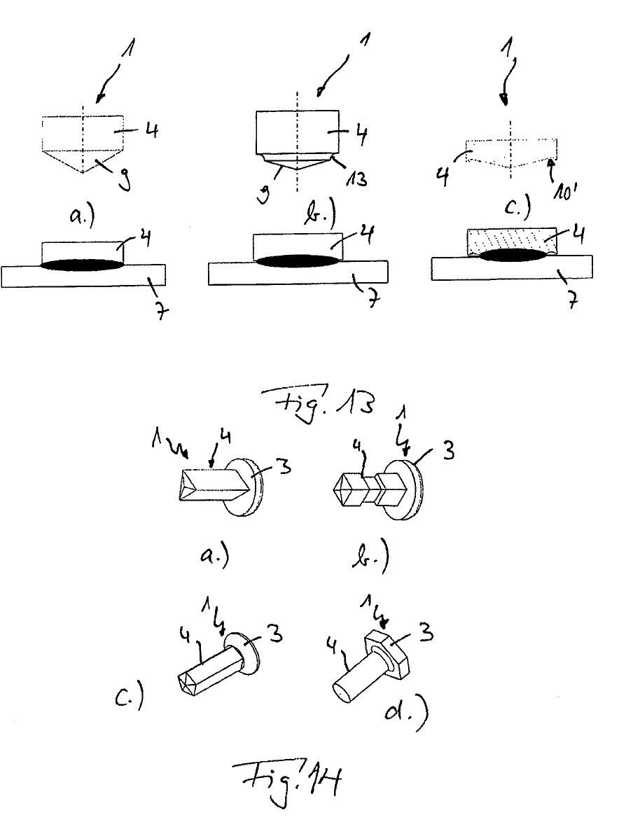

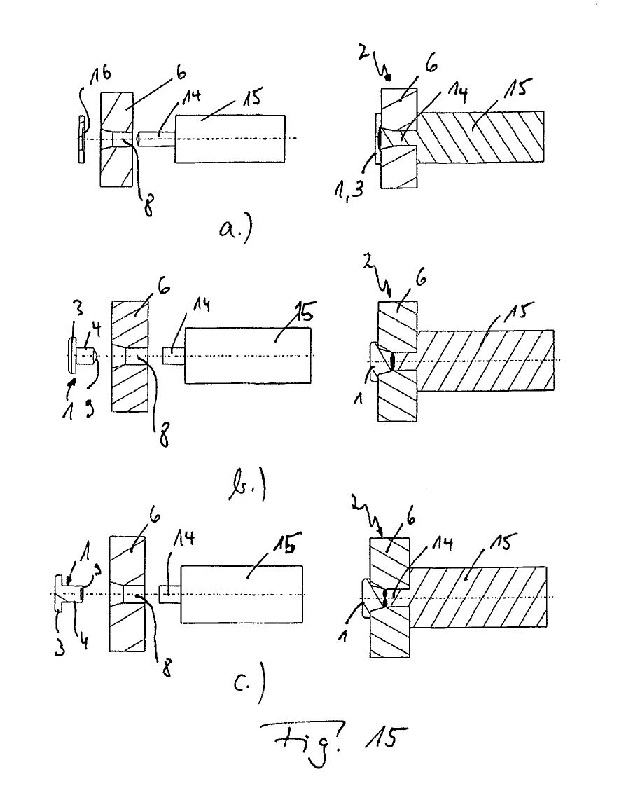

The weld rivet 1 may, in its original state, be designed without a head 3 as shown by way of example in FIGS. 11a and 12a. In this case, a head 3 stabilising the weld rivet joint 2 is produced during the riveting operation. A head 3 produced in this way is shown in FIG. 11c by way of example. It is of course possible to deform the shank 4 of the originally headless weld rivet 1 such that a head 3 can be shaped as shown in FIG. 12c by way of example.

FIGS. 13a, b and c show differently shaped end faces 9 of the shank 4 of the weld rivet 1; a conical end face 9 as shown in FIG. 13a is particularly suitable for resistance or stud welding, while an end face 9 as shown in FIG. 13b can form a chamfer 13 on the end face 9 for a subsequent bead chamber 16. Such a bead chamber 16 can alternatively be produced by a cavity 10′ as shown in FIG. 13c by way of example.

According to FIGS. 14a to d, the weld rivet 1 has a polygonal cross-section in its shank region or its head region, which secures the base component 7 against rotation relative to the component 6.

FIGS. 15a to c each shows a weld rivet joint 2 between one or more components 6 and a base component 7, wherein the component 6 also has a hole 8. The base component 7 of this embodiment is an axial extension 14 of a shaft 15, which engages the hole 8. The component 6 may accordingly be a rotor or a turbine wheel. This type of mounting may, for example, be considered for attaching a turbine wheel made of titanium aluminium to a shaft 15 made of steel or Inconel®. To solve such mounting problems, the weld rivet 1 is made of a nickel-based steel alloy, while the shaft 15 is made of steel. The weld rivet 1 according to FIG. 15a may be restricted to a rivet head 3 having a bead chamber 16 facing an end face of the axial extension 14 of the shaft 15. In FIGS. 15a to 15c, the hole 8 has a conical section, which provides for a particularly high joining force of the weld rivet joint 2.

The weld rivet shown in FIG. 15b is a solid rivet, and its end face 9 is welded to a corresponding end face of the axial extension 14. This is followed by the upsetting of the weld rivet joint 2 in the usual way. In contrast, the weld rivet 1 shown in FIG. 15c is at least partially designed as a tubular rivet and therefore has an annular end face 9 which is welded to the corresponding end face of the axial extension 14. In general, the point in the interior of the component 6, for example in the interior of the turbine wheel, where the weld rivet 1 is to be joined to the shaft 15 should be selected such that the weld rivet joint 2 can be produced cost-effectively and is thermally stable in operation.

In general, it is possible to replace conventional joints such as threaded connections by the weld rivet joint 2 according to the invention, which offers major advantages in mechanical engineering and vehicle production, in particular in engine and body production.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-18. (canceled)

19. A weld rivet joint between one or more components and a base component, wherein the one or more components have a hole through which a weld rivet having a head projects with its shank, wherein the shank is welded to a surface of the base component by its end face and is plastically deformed, wherein the weld rivet shank is shorter than a diameter of the weld rivet head, and a continuous annular recess is provided in a transition region between the head and shank to accommodate material displaced in the riveting process or for tolerance compensation.

20. The weld rivet joint according to claim 19, wherein the continuous annular recess is produced by a machining process by turning or by mechanical pinching.

21. The weld rivet joint according to claim 20, wherein the continuous annular recess is produced by an extrusion process.

22. A weld rivet joint between one or more components and a base component, wherein the one or more components have a hole through which a weld rivet having a head projects with its shank, wherein the shank is welded to a surface of the base component by its end face and is plastically deformed,
wherein the base component has a cavity that accommodates at least the end region and parts of the shank of the weld rivet.

23. The weld rivet joint according to claim 22, wherein the cavity has a conical shape.

24. A weld rivet joint between one or more components and a base component, wherein the one or more components have a hole through which a weld rivet projects with its shank, the shank is welded to a surface of the base component by its end face and is plastically deformed,
wherein the weld rivet head is recessable into the one or more components, and
wherein the hole in the one or more components is arranged such that a the head of the weld rivet is recessed on completion of the weld rivet joint.

25. Weld rivet joint according to claim 24, wherein the hole is at least partially conical.

26. A weld rivet joint between one or more components and a base component, wherein the one or more components have a hole through which a weld rivet projects with its shank, the shank is welded to a surface of the base component by its end face and is plastically deformed,
wherein the weld rivet shank is longer than a diameter of the weld rivet head, and has a continuous annular recess in its shank region.

27. The weld rivet joint according to claim 26, wherein the end face of the shank is conical.

28. The weld rivet joint according to claim 27, wherein the weld rivet is a tubular rivet and has a blind hole which is open either towards the end face of the shank or towards the head.

29. The weld rivet joint according to claim 28, wherein the shank of the weld rivet has a tubular body.

30. The weld rivet joint according to claim 29, wherein a stud bolt is provided on a side of the head of the weld rivet which is remote from the shank.

31. A weld rivet joint between one or more components and a base component, wherein the one or more components have a hole through which a weld rivet projects with its shank, wherein the shank of the weld rivet is welded by an end face to a surface of the base component and is plastically deformed, wherein the weld rivet is a headless cylindrical bolt, the head of the weld rivet being subsequently produced by plastic deformation as it is riveted into a correspondingly shaped hole.

32. A weld rivet joint between a turbine wheel and a shaft supporting the turbine wheel, the turbine wheel has a hole through which an axial extension of the shaft at least partially extends, wherein a weld rivet is welded by its end face to the end face of the axial extension and is plastically deformed.

33. The weld rivet joint according to claim 32, wherein the weld rivet is a rivet head with a bead chamber facing the end face of the axial extension of the shaft.

34. The weld rivet joint according to claim 33, wherein the weld rivet is a tubular or solid rivet and welded by its end face to the end face of the axial extension.

35. The weld rivet joint according to claim 32, wherein the shaft is made of a material that differs from that of the weld rivet, or the shaft is made of steel and the weld rivet is made of a nickel-based steel alloy.

36. The weld rivet joint according to claim 32, wherein a shank of the weld rivet has a polygonal cross-section.
